(19) United States
(12) Patent Application Publication
(10) Pub. No.: US 2007/0166136 A1
(43) Pub. Date: Jul. 19, 2007

(54) Lifter with waste container engagement member of polymeric material

(75) Inventor: Ramiro Arrez, Chicago, IL (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(73) Assignee: Perkins Manufacturing Company

(21) Appl. No.: 11/331,953

(22) Filed: Jan. 13, 2006

(51) Int. Cl. B65F 3/02

(52) U.S. Cl. 414/406

(57) ABSTRACT

A refuse container lifter for mounting on a refuse collection vehicle, the lifter being movable between a retracted and a dumping position for lifting and inverting the container. The lifter includes an upper and a lower engagement member for engaging the refuse container when the lifter is moving toward the dumping position, and at least one of the upper and/or lower engagement members has a container engaging surface of polymeric material, such as polyethylene having a molecular weight of at least 2 million, and preferably of an ultra high molecular weight polyethylene having a molecular weight of at least about 4.2 million.

### BACKGROUND AND SUMMARY OF THE INVENTION

The present invention generally relates to lifters for refuse collection containers and, more specifically, to lifters for lifting, tilting and dumping residential-style refuse containers and the container engagement members, such as hooks and stops thereon for engaging the refuse container.

Refuse container lifters have been used for many years in a wide variety of settings. They have, for example, been mounted on refuse collection trucks, both rear and side load trucks. They have been mounted on larger multi-cubic yard refuse containers and they have been used in stationary refuse loading stations. An example of one successful refuse container lifter may be found in U.S. Pat. No. 6,929,441 to Arrez et al. Despite the wide variety of lifters being offered for sale, there continues to be need for lifters that have improved reliability and/or function; that are suitable for a variety of applications on trucks, containers or stationary refuse collection stations; that may be more efficiently manufactured at reduced cost and/or that minimize or reduce the scratching or denting or other damaging of the refuse container, which is typically made of relatively thin plastic material, during lifting, tilting or dumping.

In one aspect of the present invention, a container engagement member for mounting on a refuse container lifter, comprises a first portion for mounting to the lifter and a second portion which extends from the first component to permit engagement with an engagement surface on the refuse container which is to be lifted during the lifting. At least the second portion comprises a container engaging surface of polymeric material which serves to reduce damage to the container.

The polymeric material may comprise a polyolefin, such as polyethylene, and preferably has a high molecular weight such as, at least about 2 million, and more preferably at least about 3.1 million, and still more preferably, at least about 4.2 million. Also the engagement member is preferably constructed essentially entirely of polymeric material and is of one piece construction.

These and other objects, features and advantages of the present invention will more clearly understood through a consideration of the following drawings and detailed description.

### BRIEF DESCRIPTION OF THE DRAWINGS

In the course of this description, reference will frequently be made to the attached drawings in which:

FIG. 1 is partially broken perspective view of a rear-loading refuse collection truck including two lifters embodying the present invention;

FIG. 2 is an enlarged perspective view of a typical residential collection-container that may be dumped employing a lifter of the present invention;

FIG. 3 is an enlarged perspective view of a lifter such as seen in FIG. 1 and which embodies the present invention;

FIG. 4 is a perspective view of the upper hook or engagement member of the lifter as seen in FIG. 3 and embodying the present invention;

FIG. 5 is a cross-sectional view of the upper hook as viewed substantially along line 5-5 in FIG. 4;

FIG. 6 is a perspective view of the lower stop or engagement member of the lifter as seen in FIG. 3; and

FIG. 7 is a cross-sectional view of the lower stop as viewed substantially along line 7-7 in FIG. 6.

### DETAILED DESCRIPTION OF THE PREFERRED EMBODIMENT

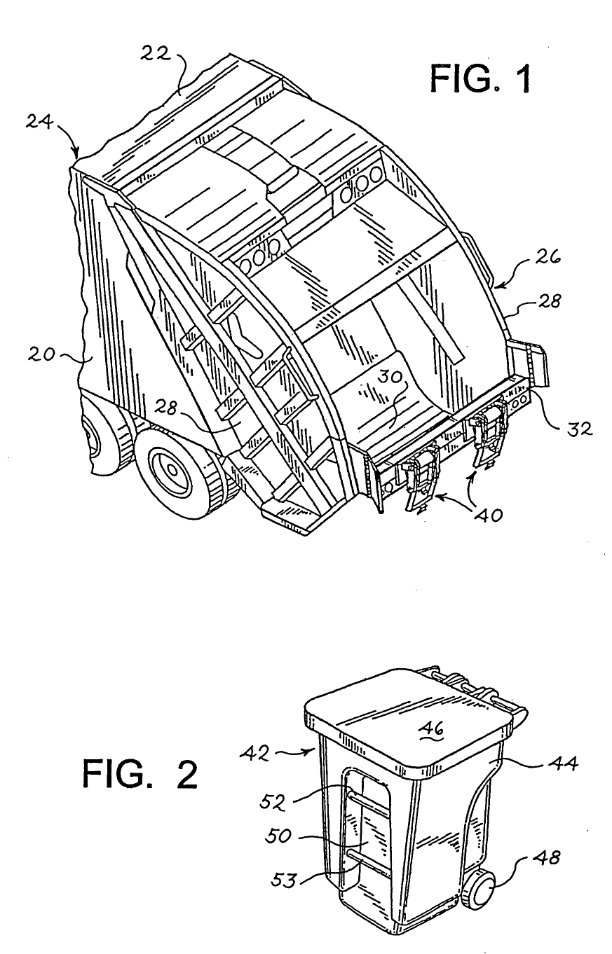

FIG. 1 illustrates a typical rear loading refuse collection truck of the type having a pair of sidewalls 20, a top wall 22, and bottom wall (not shown) forming a refuse collection body, generally at 24. A rear load hopper assembly, generally at 26, is mounted at the back of the collection body and includes sidewalls 28 and a curved bottom hopper wall 30. The bottom hopper wall slopes upwardly toward a rearward sill or sill edge 32, over which refuse is dumped into the collection hopper.

The collection truck illustrated in FIG. 1 may be adapted for dumping very large, multi-cubic yard containers, commonly referred to as dumpsters (not shown) or, as described in the aforementioned U.S. Pat. No. 6,929,441, may also be adapted to dump smaller residential style containers, as shown for example in FIG. 2.

For dumping smaller, residential style containers, the refuse collection truck shown in FIG. 1 includes two lifters 40 embodying the present invention mounted at the rear, although only one could also be used. The lifters 40 embodying the present invention are shown on the particular truck illustrated in FIG. 1 solely for purposes of illustration. The lifters embodying the present invention may also be used on side load trucks (in which refuse is added through a side opening), may be mounted on larger multi-yard containers (with suitable hydraulic attachments to a source of hydraulic fluid power), or may be mounted on stationary refuse dumping stations.

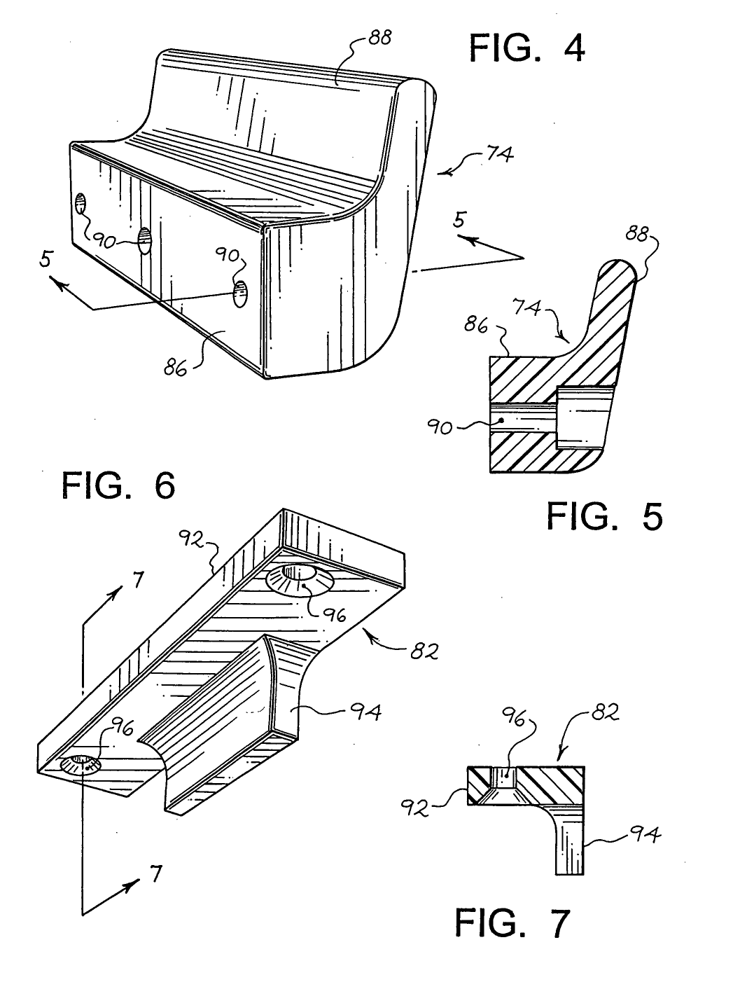

Before turning to a more detailed description of the lifter 40, reference is made to FIG. 2, which shows a typical residential roll out container 42 for which the present lifter and engagement members are intended. The typical container 42 is made of rigid plastic construction, with a body 44 and a hinged lid 46 of relatively thin walled plastic material. A pair of wheels 48 allow the container to be conveniently moved curbside or to another pickup location. The front side of the container includes a generally recessed area 50 to accommodate one of the lifters 40 on the refuse collection vehicle. For cooperation with such lifters, a pair of parallel, spaced-apart lift surfaces in the form of bars 52 and 53 are firmly secured on the container body in the recessed area 50. In other containers the lift surfaces may be molded as part of the container instead of separate bars. Lid 46 is hingedly connected to the body 44, so that the lid is naturally opened by gravity when the container is inverted for dumping, as seen in FIG. 4. It should be understood that refuse collection containers of the type shown, are available in a variety of styles and designs, and the present invention is not limited to any particular type style or design of refuse collection container.

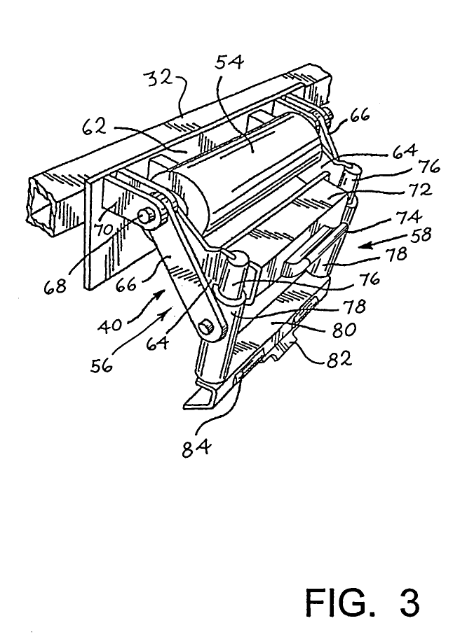

A lifter 40 embodying the present invention is perhaps best seen in FIG. 3, which is a perspective view of a lifter in an intermediate position such as is schematically shown in solid in FIG. 4, between the retracted position as shown in dotted lines and the fully raised and inverted position as shown in dot and dash lines in FIG. 4. This lifter is shown for illustrative purposes only. Other styles or types of lifters with other drive arrangements such as shown in U.S. Pat. Nos. 6,929,441, 4,911,600, 4,773,812 and 4,422,814, which are incorporated by reference herein, may also embody the present invention.

The illustrative lifter 40 embodying the present invention includes a rotary hydraulic motor or actuator 54, at least one lift arm and actuator arm generally at 56, and a container carriage, generally at 58. The hydraulic motor 54 has a generally horizontal rotary actuator shaft (not shown) that extends through at least one end of the motor, and preferably through each end of the motor. The motor 54 may be of any suitable design. The motor 54 is attached, as by welding or bolting, to a mounting or base plate 62 or it may be attached to the base plate or sill 32 in a manner to permit rapid and easy removal from or mounting to the base plate or sill.

For lifting the container carriage 58, a lift arm 64 is attached to the actuator shaft of the hydraulic motor 54, and preferably a lift arm 64 is fixed to each end of the shaft. The other ends of the lift arms 64 are attached, as by welding, bolting or other attachment, to the carriage. For inverting the carriage, an actuator arm 66 is pivotally mounted at 68 to the base plate 62 at a location beyond the end of the motor actuator shaft. Each actuator arm 66 is pivotally mounted to a bracket 70 that is welded or otherwise attached to the base plate 62. The axis of rotation at the pivot 68 is displaced from and located above the axis of rotation of the motor actuator shaft. The other end of each actuator arm 64 is pivotally attached to the carriage.

In the illustrated embodiment the carriage includes an upper cross member 72 that carries an upwardly facing container engagement member or upper hook 74 that serves to hook under the uppermost lift bar 52 on the refuse container 42 as the lifter is moved from the retracted to the extended position. Each end of the upper cross member 72 is welded or otherwise attached, directly or indirectly, to a lift arm 64 so that as the lift arm is rotated by the hydraulic motor 54, the cross member 72 is also raised or lowered.

Each side of the carriage in the illustrated embodiment includes two relatively movable or telescoping members 76 and 78. These members could be provided separately from the carriage, but making them part of the carriage reduces the number of parts and thus the material and labor costs. Inner telescoping member 76, as illustrated, is a solid cylindrical steel rod, and is attached directly or indirectly to the end of the lift arm 64 as, for example, by welding. Outer telescoping member 78, as illustrated, is a steel sleeve or tube pivotally attached to the end of the actuator arm 66. A lower cross member 80 of the carriage extends between and is attached to each of the outer telescoping members 78. The lower cross member 80 includes a downwardly facing lower container engagement member such as stop 82 for engaging over the lowermost lift bar 53 of the refuse collection container 42. The stop could also be in the shape of a downwardly facing hook or other shape without departing from the present invention and could be movable between a retracted and extended position.

As a result of the relatively movable arrangement between members 76 and 78, and the displaced axes of the pivot 68, the spacing between the upper and lower cross members 72 and 80 varies depending on the rotational position of carriage. As the rotary actuator 54 rotates counterclockwise, the carriage moves from the fully retracted position to an intermediate position. The displaced axes of the pivot 68 and motor actuator shaft causes the actuator arm 66 to push against the outer member 78, causing it to slide downwardly relative to the inner member 76, and increasing the spacing between the upper hook 74 and the lower stop 82. The upper hook 74 and lower stop 82 extend into the recessed area 50 of the container and are located between the lift bars 52 and 53, with the upper hook 74 engaging under and beginning to lift the upper lift bar 52 of the refuse collection container 42, and the lower hook being located above lower lift bar 53 of the refuse container 42.

As the lifter 40 continues to rotate upwardly, the upper hook 74 lifts the refuse container, and continued upward rotation of the lifter also results in the actuator arms 66 continuing to push the lower stop 82 away from the upper hook so that the lower stop 82 engages over the lower lift bar 53 of the collection container 42. At that position the weight of the container has generally shifted such that the lower bar 53 of the collection container rests against the lower stop 82 of the lifter 40. At this point, the distance between the upper hook 74 and lower stop 82 is such as to effectively capture the refuse collection container 40 on the lifter so that the refuse container cannot fall from the lifter as it is being lifted and dumped. More specifically, the upper hook 74 and lower stop 82 are spaced apart nearly the same distance that the upper and lower lift bars 52 and 53 of the refuse container 42 are spaced apart, so that the container cannot shift enough that either lift bar can be removed from its respective hook or stop. The relative motion of the upper hook 74 and lower stop 82 is reversed as the lifter rotates back toward the retracted position, with the inner and outer members 76 and 78 sliding or telescoping together, drawing the cross members 72 and 80, and their respective upper hook 74 and low. stop 82 closer together for release of the container.

As noted earlier, the container carriage, with relatively movable upper hook 74 and lower stop 82, could be a separate assembly operatively attached to the relatively movable members 76 and 78 for moving the hooks. In the illustrated embodiment the relatively movable members 76 and 78 are directly attached, respectively, to the cross members 72 and 80, which tends to reduce cost and simplify construction.

In addition to the lower stop 82, the lower cross member 80 also preferably mounts a pair of rollers 84 to protect the wall of the container as it is lifted, tilted and dumped. As noted earlier, the upper hook 74 and lower stop 82 extend into the recessed area 50 of the collection container and the rollers 84 serve to support the container wall to minimize gouging by the lower hook or damage to the container as the lower hook moves downwardly during rotation of the carriage.

In addition, to further reduce gouging or other damage to the plastic container in accordance with the present invention, the upper hook 74 and/or lower stop 82 have a container engaging surface of polymeric material.

The construction and operation of the lifter 40 together with various modifications are described in detail in the aforementioned U.S. Pat. No. 6,929,441, the content of which is incorporated herein by reference.

The present invention is directed to an improved upper hook 74 and/or lower stop 82 on the lifter 40 as previously described.

Referring to FIGS. 4 and 5, the preferred upper hook 74 of the present invention is generally L-shaped in cross section and includes a first portion 86 and second portion 88 which are preferably but not necessarily, formed integrally with each other and in which the second portion 88 extends at a substantial angle to the first portion 86. The first portion 86 includes a plurality of horizontally extending passages 90 therethrough to accommodate bolts (not shown) or other suitable fasteners for fastening the upper hook 74 to the upper cross member 72 of the lifter 40 as seen in FIG. 3. When the first portion 86 is fastened to the upper cross member, the second portion 88 extends upwardly at a substantial angle to the first portion to define a hook or saddle having a container engaging surface and in readiness to receive the upper lift surface, such as bar 52,on the container.

Referring to FIGS. 6 and 7, the lower stop 82 also includes a first portion 92 and a second portion 94 which is preferably formed integrally with the first portion 92 and extends outwardly at a substantial angle to the first portion of the lower stop 82. The first portion 92 of the lower stop 82 also includes a plurality of passages 96 which extend through the first portion to receive bolts (not shown) or other equivalent fasteners for mounting the first portion 82 to the lower cross member 80 as seen in FIG. 3. When the first portion 92 is fastened to the lower cross member, the second portion 94 extends outwardly at a substantial angle to the first portion and has a container engaging surface in readiness to engage the lower lift bar 53 on the container.

In the present invention, container engagement members such as the upper hook 74 and/or lower stop 82 are preferably formed entirely of a very hard, but low abrasion polymer. Such polymer minimizes the wear during use on the upper hook 74 and/or lower stop 82 while facilitating. engagement and disengagement of the upper hook and/or lower stop with the lift bars 52 and 53 on the container 42, and it also minimizes any possibility of scratching or gouging of the container 42 during use.

A preferred polymer for the upper hook 74 and/or lower stop 82 is a very high molecular weight polyolefin, preferably high density polyethylene, and more preferably, of an ultra high molecular weight polyethylene. The molecular weight of the polyethylene is preferably at least about 2 million, more preferably at least about 3.1 million, and most preferably at least about 4.2 million. Such polyethylenes include GAR-DUR® which is available from Garland Mfg. Company, Saco, Me.

Although the engagement members are preferably formed essentially entirely of polymeric material, forming a one-piece construction as illustrated above that may be molded, the engagement members may also be of multi-component construction. For example, the engagement members may have a core of steel or other high strength material entirely or partially coated with a suitable polymeric material so that the container contacting surface of the engagement member is of polymeric material to reduce container damage. Alternatively, the engagement member may be made of steel or other high strength material and only the portion that is likely to contact or damage a container may be of polymeric material or may be coated or covered with the desired polymeric material.

It will be understood that the preferred embodiment of the present invention which has been described is merely illustrative of the principles of the present invention. Numerous modifications may be made by those skilled in the art without departing from the true spirit and scope of the invention.

1. A container engagement member for mounting on a refuse container lifter, comprising
a first portion for mounting to a lifter;
a second portion which extends from said first portion to permit engagement with an engagement surface on a refuse receptacle which is to be lifted during the lifting; and
wherein at least said second portion comprises a container engaging surface of polymeric material.

2. The engagement member of claim 1, wherein the member defines a hook or a stop for a refuse container lifter.

3. The engagement member of claim 1, wherein said polymeric material comprises a polyolefin.

4. The engagement member of claim 1, wherein said polymeric material comprises polyethylene.

5. The engagement member of claim 1, wherein said polymeric material has a molecular weight of at least about 2 million.

6. The engagement member of claim 5, wherein said polymeric material is polyethylene.

7. The engagement member of claim 1, wherein said polymeric material has a molecular weight of at least about 3.1 million.

8. The engagement member of claim 7, wherein said polymeric material is polyethylene.

9. The engagement member of claim 1, wherein said polymeric material has a molecular weight of at least about 4.2 million.

10. The engagement member of claim 9, wherein said polymeric material is polyethylene.

11. The engagement member of claim 1 wherein said first and second portions are constructed essentially entirely of said polymeric material.

12. The engagement member of claim 1 wherein at least said second portion comprises a core and said polymeric material is carried on said core.

13. The engagement member of claim 1 wherein said engagement member is of one-piece construction.

14. A refuse container lifter for mounting on a refuse collection vehicle, the lifter being movable between a retracted position and a dumping position for lifting and inverting the container, the lifter including
an upper engagement member and a lower engagement member for engaging the refuse container when the lifter is moving toward the dumping position; and
at least one of said upper and lower engagement members comprising a container engaging surface of polymeric material.

15. The lifter of claim 14, wherein said polymeric material is a polyolefin.

16. The lifter of claim 14, wherein said polymeric material is polyethylene.

17. The lifter of claim 14, wherein said polymeric material has a molecular weight of at least about 2 million.

18. The lifter of claim 17, wherein said polymeric material is polyethylene.

19. The lifter of claim 14, wherein said polymeric material has a molecular weight of at least about 3.1 million.

20. The lifter of claim 19, wherein said polymeric material is polyethylene.

21. The lifter of claim 14, wherein said polymeric material has a molecular weight of at least about 4.2 million.

22. The lifter of claim 21, wherein said polymeric material is polyethylene.

23. A refuse container lifter for mounting on a refuse collection vehicle, the lifter being movable between a retracted position and a dumping position for lifting and inverting the container, the lifter including
an upper container engagement member and a lower container engagement member for engaging the refuse container when the lifter is moving toward the dumping position, at least one of said upper and lower engagement members being constructed of an ultra high molecular weight polymeric material having a molecular weight of at least about 3.1 million.

24. The lifter of claim 23, wherein said polymeric material has a molecular weight of a least about 4.2 million.

25. The lifter of claim 24, wherein said polymeric material is polyethylene.
